(19) United States
(12) Patent Application Publication
(10) Pub. No.: US 2014/0286253 A1
(43) Pub. Date: Sep. 25, 2014

(54) INFORMATION PROCESSING APPARATUS AND METHOD

(71) Applicant: BUFFALO INC., Nagoya-shi (JP)

(72) Inventors: Nagahiro MATSUURA, Nagoya-shi (JP); Daisuke Yamada, Nagoya-shi (JP); Tomoaki Ohara, Nagoya-shi (JP); Goki Ichikawa, Nagoya-shi (JP)

(73) Assignee: BUFFALO INC., Nagoya-shi (JP)

(21) Appl. No.: 14/220,707

(22) Filed: Mar. 20, 2014

(30) Foreign Application Priority Data
Mar. 22, 2013 (JP) 2013-59656

(51) Int. Cl. H04W 72/08

(52) U.S. Cl. CPC H04W 72/082
USPC 370/329

(57) ABSTRACT

A channel for which connection has been established is classified into an unavailable channel or an available channel. When there are a plurality of available channels, one or more channels among the plurality of available channels is selected as a channel for which connection is to be maintained for communication.

### CROSS-REFERENCE TO RELATED APPLICATIONS

The present application claims priority from Japanese Patent Application No. 2013-059656 filed on Mar. 22, 2013, the entirety of disclosure of which is hereby incorporated by reference into this application.

### TECHNICAL FIELD

The disclosure relates to information processing.

### BACKGROUND ART

During wireless communication in a communication mode using two adjacent channels, when radar wave is detected at one of the channels, a known technique changes the communication mode to a mode using alone the other channel for which radar wave is not detected (for example, JP 2007-005897A).

The problem of the above prior art is no consideration of the case that there are a plurality of available channels allowing for continuing use, when any of a plurality of channels is temporarily suspended during wireless communication using the plurality of channels. This problem is also applied to the case of changing the channel by a reason other than detection of radar wave. Other needs include, for example, downsizing of a device, resource saving, easiness of manufacture and improved usability.

### SUMMARY

According to one aspect of the disclosure, there is provided an information processing apparatus. This information processing apparatus comprises: circuitry configured to classify a channel for which connection has been established as an unavailable channel or an available channel; and select, when there are a plurality of available channels, one or more channels among the plurality of available channels as a channel for which connection is to be maintained.

### BRIEF DESCRIPTION OF DRAWINGS

FIG. 1 is a schematic configuration diagram of a network system;

FIG. 2 is a block diagram illustrating the internal configuration of a wireless communication device;

FIG. 3 is a diagram illustrating a channel bonding in a 5 GHz band;

FIG. 4 is a flowchart showing a channel control process;

FIG. 5 is a flowchart showing a channel change trigger detection process;

FIG. 6 is a flowchart showing a channel candidate determination process;

FIG. 7 is a channel selection process;

FIG. 8 is a block diagram illustrating the internal configuration of a wireless communication device according to another embodiment; and

FIG. 9 is a flowchart showing another embodiment of the channel selection process.

### DESCRIPTION OF EMBODIMENTS

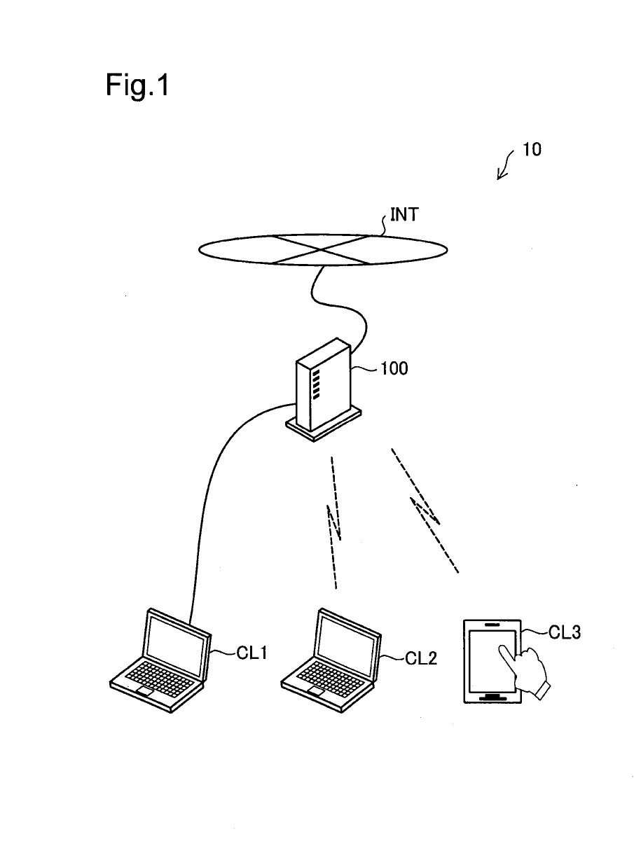

FIG. 1 illustrates the schematic configuration of a network system 10. The network system 10 includes a wireless communication device 100 and three client devices CL1, CL2 and CL3.

The wireless communication device 100 is a wireless LAN access point in conformity with the IEEE 802.11 standard. The wireless communication device 100 is connected to the Internet INT via a cable. The wireless communication device 100 also serves as a third layer router in the OSI reference model. The wireless communication device 100 relays wireless communication and wired communication with the client devices CL1, CL2 and CL3.

The client device CL1 is a personal computer equipped with a wired communication interface in conformity with the IEEE 802.3 standard. The client device CL2 is a personal computer equipped with a wireless communication interface in conformity with the IEEE 802.11 standard.

The client device CL3 is a smartphone equipped with a wireless communication interface in conformity with the IEEE 802.11 standard. In the illustrated example of FIG. 1, the client device CL1 is connected with the wireless communication device 100 with wire, and the client devices CL2 and CL3 are connected with the wireless communication device 100 wirelessly.

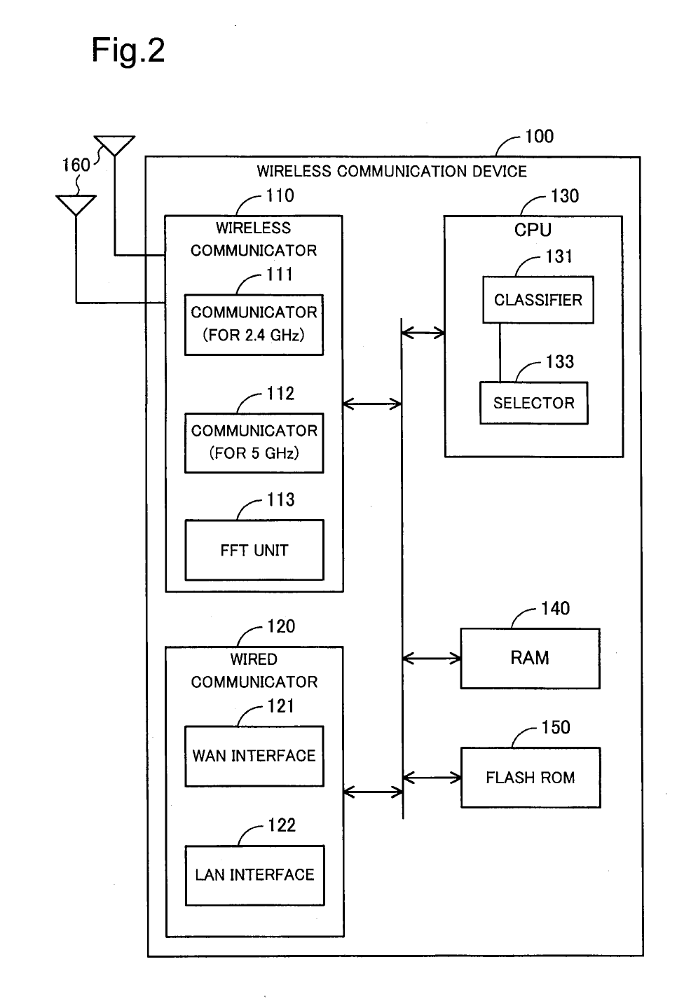

FIG. 2 is a block diagram illustrating the internal configuration of the wireless communication device 100. FIG. 2 does not show the configuration that is not necessary for description of the embodiment. The wireless communication device 100 includes a wireless communicator 110, a wired communicator 120, a CPU 130, a RAM 140 and a flash ROM 150. These are interconnected via a bus.

The wireless communicator 110 includes a communicator 111 (for 2.4 GHz), a communicator 112 (for 5 GHz), an FFT unit 113 and antennas 160. The wireless communicator 110 performs demodulation of radio waves received via the antenna 160 and generation of data, as well as generation and modulation of radio waves to be sent via the antenna 160. The wireless communicator 110 employs MIMO (Multiple Input Multiple Output).

The communicator 111 makes communication using channels belonging to a 2.4 GHz band in conformity with the wireless LAN standard. The communicator 112 makes communication using channels belonging to a 5 GHz band in conformity with the wireless LAN standard.

The FFT unit 113 utilizes FFT (Fast Fourier Transform) to split signals obtained via the antenna 160 into frequency bands of all subcarriers and simultaneously obtain the signal strengths of all subcarriers. All subcarriers indicate entire subcarriers respectively constituting all channels. All channels include channels usable in the 2.4 GHz band and channels usable in the 5 GHz band. The signal strengths obtained by the FFT unit 113 are used for detection of radar waves in W53 and W56 and for calculation of RSSIs (Received Signal Strength Indicators) of the respective channels. W53 and W56 are respectively channel groups in the 5 GHz band.

The wired communicator 120 performs a process of shaping the waveform of a received signal and a process of extracting a MAC frame from the received signal. The wired communicator 120 includes a WAN interface 121 and a LAN interface 122. The WAN interface 121 is connected with a line on the Internet INT side. The LAN interface 122 is connected with the client device CL1 according to this embodiment.

The CPU 130 performs a channel control process (described later) to serve as a classifier 131 and a selector 133. A program for enabling the channel control process is stored in the flash ROM 150. The classifier 131 classifies a plurality of channels into temporarily suspended or unavailable channels and available channels allowing for continuing use. The plurality of channels to be classified are channels which establish connection by channel bonding described later. The selector 133 selects one or more channels among a plurality of available channels if any, as a connection retaining channel.

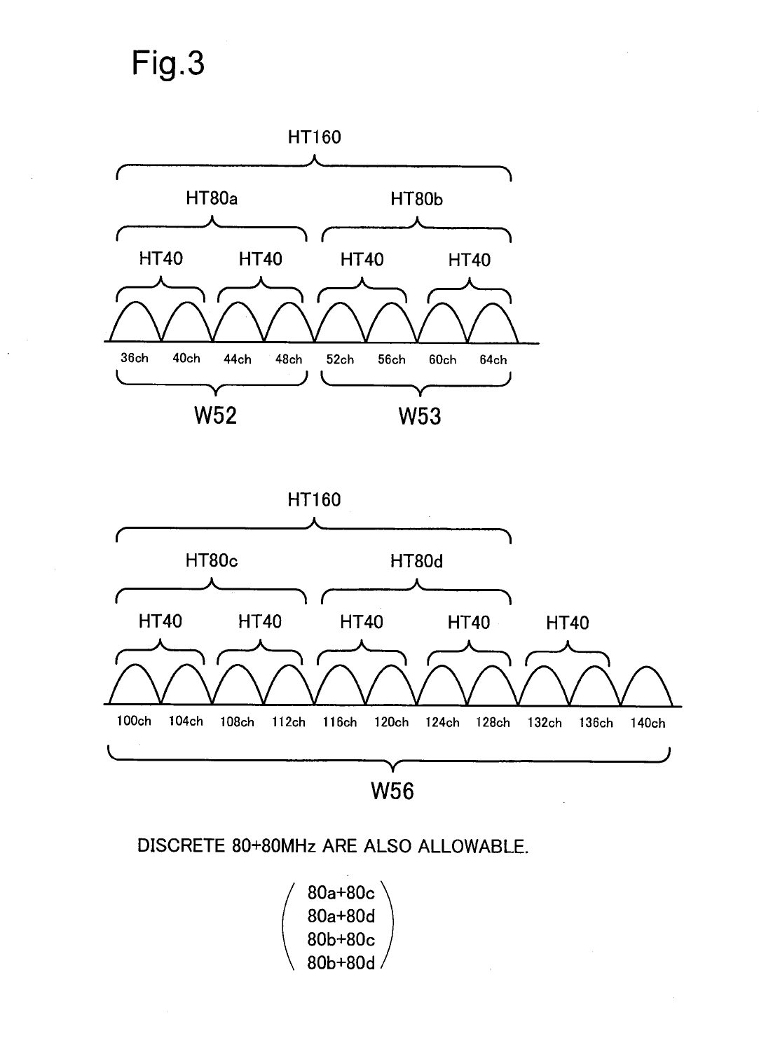

FIG. 3 is a diagram illustrating channel bonding in the 5 GHz band. The bandwidth of each channel is 20 MHz. The wireless communication device 100 of this embodiment employs channel bonding defined by IEEE 802.11n/ac. Channel bonding is a technique of making communication with bonding a plurality of channels, so as to expand the band. When eight channels are bonded to expand the band to 160 MHz (HT160), the embodiment does not limit successive HT80 bands but may combine discrete HT80 bands.

The wireless communication device 100 selects at least one channel in accordance with the rules of channel bonding and establishes wireless connection with a client device. Establishing wireless connection enables the state communicable with the client device.

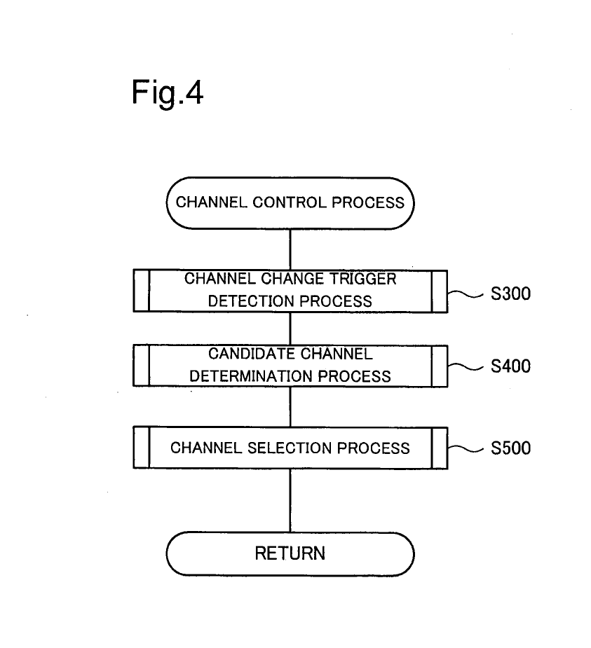

FIG. 4 is a flowchart showing a channel control process. The channel control process is repeatedly performed by the CPU 130, while the wireless communication device 100 establishes wireless connection with at least one client device. The CPU 130 performs detection of radar waves in the power-ON state of the wireless communication device 100, whether or not wireless connection is established with any client device.

On the start of the channel control process, the CPU 130 repeatedly performs a channel change trigger detection process (step S300), a candidate channel determination process (step S400) and a channel selection process (step S500) in this order.

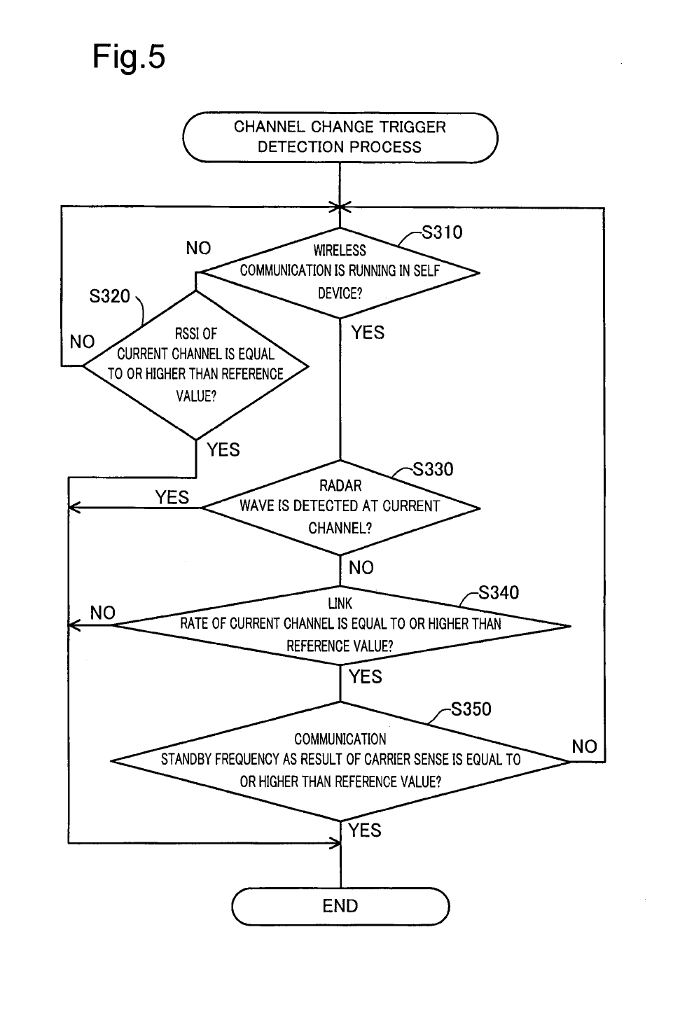

FIG. 5 is a flowchart showing the channel change trigger detection process. The CPU 130 first determines whether wireless communication is running in the wireless communication device 100 (step S310). “Wireless communication is running” means that not only wireless connection is established but data transmission and reception is running. “Wireless communication is not running”, on the other hand, means that wireless connection is established but data transmission and reception is not running.

Wireless communication is not running (step S310: NO), the CPU 130 determines whether the RSSI of each channel that currently establishes wireless connection (hereinafter referred to as “current channel”) is equal to or greater than a reference value (step S320). RSSI herein indicates the received signal strength at each current channel including radio waves transmitted from other communication terminals and noises. The number of current channels may be any of 1, 2, 4 and 8 according to the implementation status of channel bonding. When the number of current channels is equal to 2 or more, an average value of all the current channels in a specified time may be employed as the above “RSSI of the current channel” or alternatively a maximum value of all the current channels in a specified time may be employed as the above “RSSI of the current channel”.

According to this embodiment, a predetermined fixed value is employed for the above reference value of RSSI. The reference value of RSSI is determined based on a value expected to have a significant reduction in effective throughput by interference (for example, 50% of maximum received signal strength). The subsequent flow of the channel control process includes steps of determining whether each of various parameters is equal to or higher than a reference value. According to this embodiment, predetermined fixed values are employed for all such reference values.

When the RSSI of the current channel is less than the reference value (step S320: NO), the CPU 130 returns to step S310 and repeatedly executes step S310 and step S320 until wireless communication starts running or until the RSSI of the current channel becomes equal to or greater than the reference value.

When the RSSI of the current channel is equal to or greater than the reference value (step S320: YES), the CPU 130 terminates the channel change trigger detection process. Subsequently the CPU 130 performs the candidate channel determination process and the channel selection process, in order to try to change the channel for which connection is established from the current channel to another channel (hereinafter this change is referred to as “change the channel”). The CPU 130 changes the channel when the RSSI of the current channel is equal to or greater than the reference value at step S320, because of the following reason: in the case that a signal of high strength is received from another communication terminal while wireless communication is not running in the self device, starting communication without changing the channel is likely to reduce the effective throughput by interference.

When wireless communication is running in the wireless communication device 100 (step S310: YES), on the other hand, the CPU 130 determines whether any radar wave is detected at the current channel (step S330). Channels subjected to detection of radar waves are channels belonging to either W53 or S56. Channels belonging to W52 and channels belonging to the 2.4 GHz band are not in the shared band with radar waves. Accordingly neither the channels belonging to W52 nor the channels belonging to the 2.4 GHz band are subjected to detection of radar waves. The CPU 130 according to this embodiment obtains information on signal strengths from the FFT unit 113 even with respect to channels other than the current channel, but detection of radar waves is performed at the current channel.

When any radar wave is detected at the current channel (step S330: YES), the CPU 130 terminates the channel change trigger detection process to avoid the radar wave and performs the candidate channel determination process (step S400 in FIG. 4) and the channel selection process (step S500 in FIG. 4), in order to try to change the channel.

When no radar wave is detected at the current channel (step 330: NO), the CPU 130 determines whether a link rate of the current channel is equal to or higher than a reference value (step S340). This link rate means link speed of the wireless communication device 100 with a client device. The reference value of the link rate may be determined, for example, based on whether a value enables sensing of reduction in communication rate. This reference value may be, for example, 50% of a maximum link rate allowable at the current channel. When the link rate of the current channel is lower than the reference value (step S340: NO), the CPU 130 terminates the channel change trigger detection process to enhance the link rate and performs the candidate channel determination process (step S400 in FIG. 4) and the channel selection process (step S500 in FIG. 4), in order to try to change the channel.

When the link rate of the current channel is equal to or higher than the reference value (step S340: YES), the CPU 130 determines whether a transmission standby frequency as a result of carrier sense is equal to or higher than a reference value (step S350). This carrier sense is defined according to IEEE 802.11 and checks whether the current channel is being used by another communication terminal. When the current channel is being used by another communication terminal, transmission of data is stood by. The reference value of the transmission standby frequency may be determined, for example, based on whether a value enables sensing of reduction in communication rate. This reference value (frequency) may be, for example, 50%.

When the transmission standby frequency as the result of carrier sense is lower than the reference value (step S350: NO), the CPU 130 returns to step S310 and continues the channel change trigger detection process. When the transmission standby frequency as the result of carrier sense is equal to or higher than the reference value (step S350: YES), the CPU 130 terminates the channel change trigger detection process to suppress interference and performs the candidate channel determination process (step S400 in FIG. 4) and the channel selection process (step S500 in FIG. 4), in order to try to change the channel.

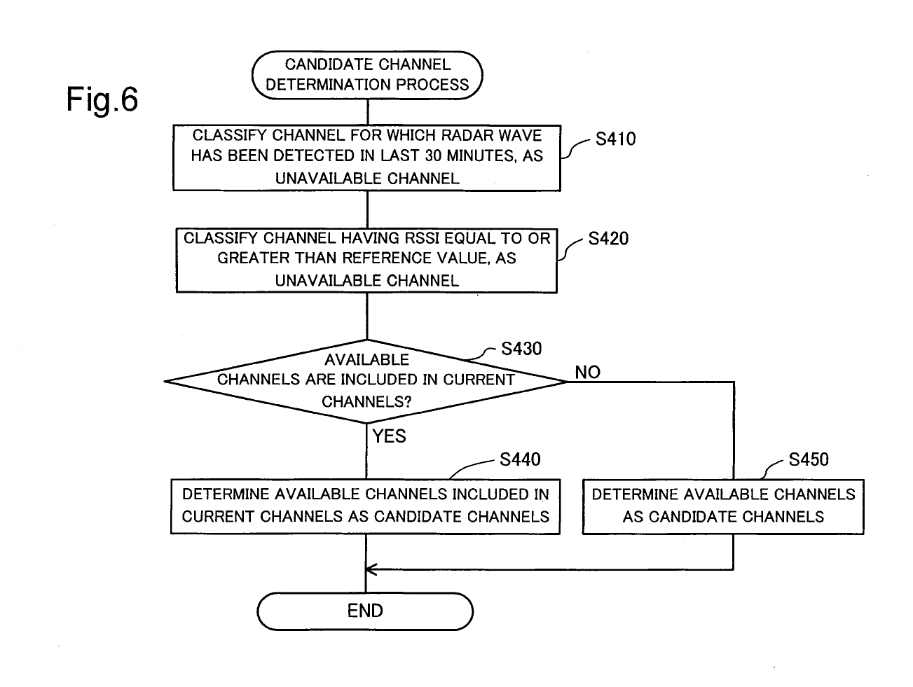

FIG. 6 is a flowchart showing the candidate channel determination process. The classifier 131 of the CPU 130 first classifies any channel for which radar wave has been detected in last 30 minutes as an unavailable channel among all the channels of W53 and W56 (step S410). This is because wireless communication is not allowed for subsequent 30 minutes with respect to a channel for which radar wave has been detected according to IEEE 802.11. The CPU 130 utilizes the FFT unit 113 to identify a channel for which radar wave has been detected among the channels constituting the current channels. Step S410 is performed on the basis of this identification. Even when radar wave is detected in the state that connection of a plurality of channels is established by channel bonding, all the channels establishing connection are not always classified as the “channel for which radar wave has been detected in last 30 minutes”. The channel classified as an unavailable channel is excluded from candidates for a channel to be switched over.

The classifier 131 of the CPU 130 subsequently classifies any channel having the RSSI equal to or greater than the reference value among all the channels in the state that wireless communication is not running, as an unavailable channel (step S420). The classifier 131 classifies each channel which has not been classified as an unavailable channel at step S410 or S420, as a channel allowing for continuing use, i.e., as an available channel. The CPU 130 subsequently determines whether at least one of the available channels is included in the current channels (step S430).

When at least one of the available channels is included in the current channels (step S430: YES), the CPU 130 determines the available channels included in the current channels among all the available channels, as candidate channels (step S440). The candidate channels are determined in this way with a view to omission of CAC (Channel Availability Check). This is because it may be considered that CAC has been complied with for the current channels. CAC performs radar wave detection at a channel to be connected for a predetermined time (1 minute), in order to guarantee that no radar is operated at the channel, prior to establishment of wireless communication. During radar wave detection, the wireless communication device 100 cannot make communication. Omission of CAC can avoid such a standby time.

When none of the available channels is included in the current channels (step S430), the available channels are determined as candidate channels (step S450).

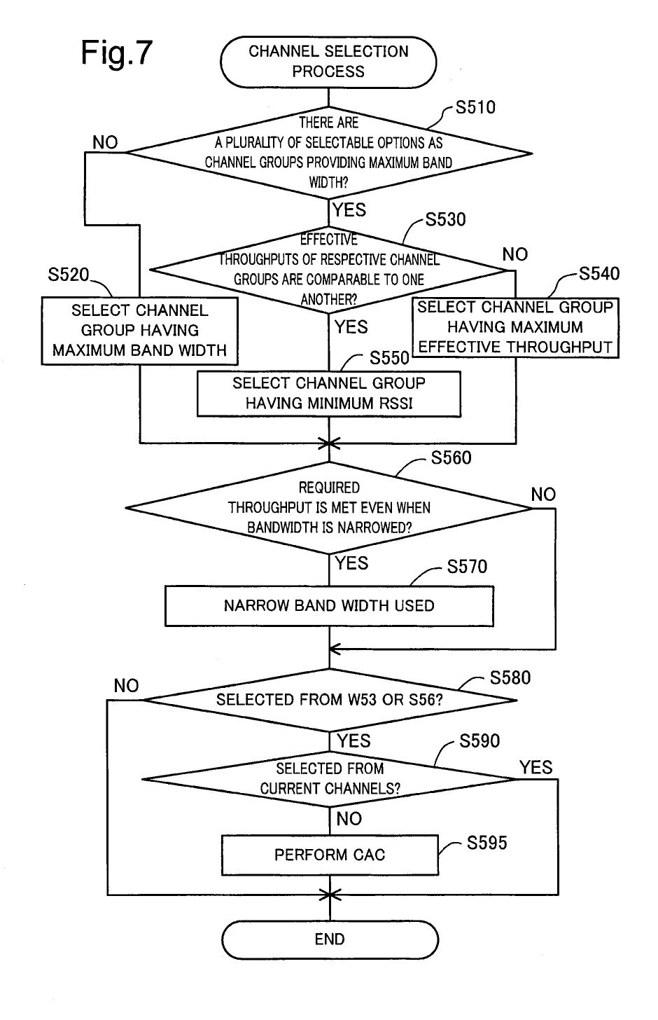

FIG. 7 is a flowchart showing the channel selection process. The CPU 130 first determines whether there are a plurality of selectable options as channel groups providing a maximum band width (step S510). Each channel group herein means a single channel or a set of two or more channels. With respect to the combination of two or more channels, the combination complying with the rules of channel bonding described above is permitted according to this embodiment.

The channels selectable at step S510 are the candidate channels determined by the candidate channel determination process. When the candidate channels are 36ch to 64ch and 100ch to 128ch (when the unavailable channels are 132ch to 140ch), the maximum band width is 160 MHz, and there are six selectable options providing 160 MHz. When the candidate channels are 36ch to 60ch (when the unavailable channels are 64ch and 100ch to 140ch), on the other hand, the maximum band width is 80 MHz, and there is only one selectable option (4 channels of 36ch to 48ch) providing 80 MHz.

When there is only one selectable option as a channel group providing the maximum band width (step S510: NO), the selector 133 of the CPU 130 selects this channel group (step S520).

When there are a plurality of selectable options as channel groups providing the maximum band width (step S510: YES), the CPU 130 measures the effective throughput of each channel group providing the maximum band width and determines whether the effective throughputs of the respective channel groups are comparable to one another (step S530). This determination is based on whether the difference between a maximum value and a minimum value of the effective throughputs of the respective channel groups is less than a reference value.

When the effective throughputs of the respective channel groups providing the maximum band width are not comparable to one another (step S530: NO), the selector 133 of the CPU 130 selects a channel group having the maximum effective throughput (step S540).

When the effective throughputs of the respective channel groups providing the maximum band width are comparable to one another (step S530: YES), the selector 133 of the CPU 130 selects a channel group having a minimum average RSSI in a specified time when wireless communication is not running (step S550). A channel group is selected to minimize interference of radio wave by step S550.

After execution of any of steps S520, S540 and S550, the CPU 130 determines whether the effective throughput meets a required throughput even when the band width is narrowed (step S560). The required throughput indicates a throughput required according to the type (application) of active communication.

In the case that the effective throughput meets the required throughput even when the band width is narrowed (step S560: YES), the selector 133 of the CPU 130 sets a narrowest possible band width in a range that meets the required throughput (step S570). Narrowing the band width is likely to avoid the band from being occupied beyond necessity. Narrowing the band width can also avoid radar wave detection at a channel suspended for narrowing the band width. This accordingly reduces the channels classified as unavailable channels. The CPU 130 may decrease the number of channels subjected to bonding, in order to narrow the band width.

In the case that the effective throughput does not meet the required throughput when the band width is narrowed (step S560: NO), the CPU 130 skips step S570. “The case that the effective throughput does not meet the required throughput when the band width is narrowed” includes the case that the effective throughput does not meet the required throughput even when the band width is not narrowed. When only one channel is selected at any of steps S520, S540 and S550, it is not allowed to further narrow the band, so that the decision is NO at step S560.

The CPU 130 subsequently determines whether at least one of the channels included in the selected channel group belongs to either W53 or W56 (step S580). When at least one of the channels included in the selected channel group belongs to either W53 or W56 (step S580: YES), the CPU 130 determines whether all the channels included in the selected channel group are included in the current channels (step S590). In other words, the CPU 130 determines whether step S440 has been executed in the candidate channel determination process.

When at least one channel included in the selected channel group is not included in the current channels (step S590: NO), the CPU 130 performs CAC with respect to the selected channel group (step S595) and terminates the channel selection process. After that, connection of the selected channel group is established.

When at least one of the conditions that none of the channels included in the selected channel group belongs to either W53 or W56 (step S580: NO) and that all the channels included in the selected channel group are included in the current channels (step S590: YES), CAC is not required. The CPU 130 accordingly terminates the channel selection process without performing step S595.

The channel control process described above is on the premise that a channel is selected from the 5 GHz band. In some cases, however, it is not adequate to select a channel from the 5 GHz band. In this case, the selector 133 of the CPU 130 selects a channel from the 2.4 GHz band. The case where selection of a channel from the 5 GHz band is not adequate may be, for example, the case where radar wave has been detected within 30 minutes with respect to all the channels belonging to the 5 GHz band or the case where all the channels belonging to the 5 GHz band have large RSSIs.

According to the embodiment described above, in the state of bonding 4 channels or 8 or more channels, when radar wave is detected at the current channel, the procedure can select a channel advantageous for communication among a plurality of channels classified as available channels, as a channel after change (i.e., as a channel for which connection is to be maintained), while avoiding CAC. Additionally, when a channel is changed by a reason other than detection of radar wave (i.e., reason that the link rate is lower than the reference value or that the transmission standby frequency is equal to or higher than the reference value), the procedure can also select a channel advantageous for communication among a plurality of channels classified as available channels, as a channel after change.

The disclosure is not limited to the above embodiments, examples or modifications, but a diversity of variations and modifications may be made to the embodiments without departing from the scope of the disclosure. For example, the technical features of the embodiments, examples or modifications corresponding to the technical features of the respective aspects described in SUMMARY may be replaced or combined appropriately, in order to solve part or all of the problems described above or in order to achieve part or all of the advantageous effects described above. Any of the technical features may be omitted appropriately unless the technical feature is described as essential herein.

The method of channel bonding and/or the operations related to radar wave may be changed from the techniques described in the embodiment. For example, a technique according to the laws and regulations at the time and at the location of implementation may be employed.

In the channel change trigger detection process, the parameters to be noted may be changed. For example, only when radar wave is detected, the procedure may terminate the channel change trigger detection process and try to change the channel. In another example, only when the link rate is lower than the reference value, the procedure may terminate the channel change trigger detection process and try to change the channel. In yet another example, only when the transmission standby frequency is equal to or higher than the reference value, the procedure may terminate the channel change trigger detection process and try to change the channel.

The method of determining candidate channels may be changed. For example, all the channels other than the channels for which radar wave has been detected within 30 minutes may be determined as candidate channels. In another example, all the channels having RSSIs of less than the reference value may be determined as candidate channels.

The technique of selecting a channel group to be switched over may be changed. The embodiment employs the procedure of selecting a channel group sequentially based on the band width, based on the effective throughput and based on the RSSI. According to other embodiments, this sequence may be changed; selection based on any of these parameters may be omitted; or selection may be based on another parameter (for example, link rate).

In the channel selection process, step S560 and S570 may be omitted. The channel selection may be performed such that a primary channel is not changed. In the case of not changing the primary channel, communication may be continued without reconnection. A protocol of 20/40 Coexistence element in the IEEE 802.11 standard (2012) may be used for such communication without reconnection.

The reference value used at each determination step may be varied. For example, the reference value of the link rate at step S340 may be varied according to the type of communication. For example, the reference value may be increased in the case of downloading large data. The case where large data is downloaded may be, for example, streaming or downloading an application program.

Part of the functions implemented by the software configuration according to the embodiment may be implemented by hardware configuration. Part of the functions implemented by the hardware configuration according to the embodiment may be implemented by software configuration.

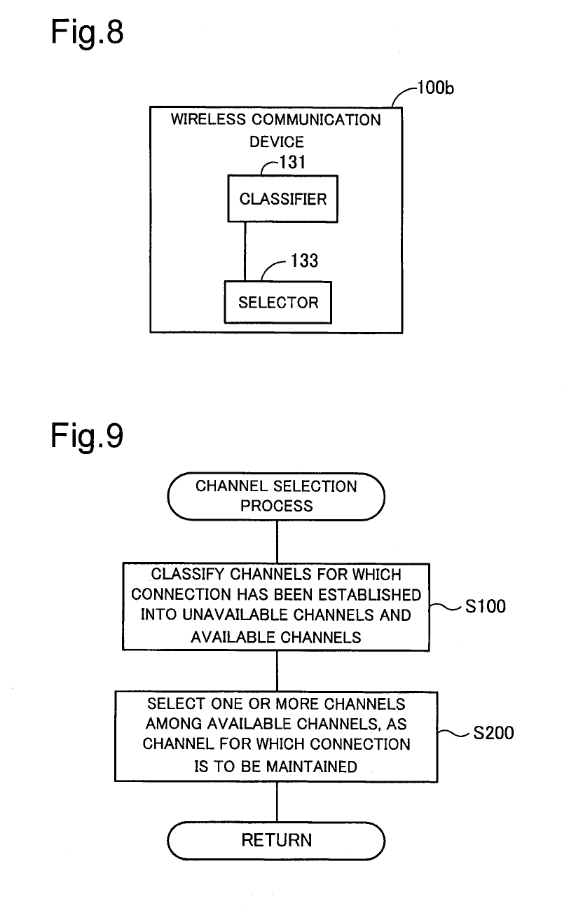

FIG. 8 is a block diagram illustrating the internal configuration of a wireless communication device 100b according to another embodiment. The wireless communication device 100b includes a classifier 131 and a selector 133. The classifier 131 and the selector 133 of the wireless communication device 100b have the similar functions to those of the classifier 131 and the selector 133 of the embodiment described above.

FIG. 9 is a flowchart showing another embodiment of the channel selection process. This channel selection process is triggered, for example, when radar wave is detected at a channel for which connection has been established, when the link rate of a channel for which connection has been established is lower than the reference value, or when the transmission standby frequency is equal to or higher than the reference value. When this channel selection process is triggered, the classifier 131 of the CPU 130 classifies channels for which connection has been established into temporarily suspended channels and available channels allowing for continuing use (step S100). When there are a plurality of available channels, the selector 133 of the CPU 130 selects one or more channels among the plurality of available channels, as a channel for which connection is to be maintained (step S200). When any of a plurality of channels is temporarily suspended during wireless communication using the plurality of channels, in the case that there are a plurality of channels allowing for continuing use, the procedure can select a channel for which establishment of connection is to be maintained, among the channels allowing for continuing use.

Additionally, according to one aspect of the disclosure, there is provided a wireless communication device described below.

(1) An information processing apparatus, comprising: circuitry configured to classify a channel for which connection has been established as an unavailable channel or an available channel; and select, when there are a plurality of available channels, one or more channels among the plurality of available channels as a channel for which connection is to be maintained. When any of a plurality of channels is temporarily suspended during wireless communication using the plurality of channels, in the case that there are a plurality of channels allowing for continuing use, this aspect can select a channel for which establishment of connection is to be maintained, among the channels allowing for continuing use.

(2) According to one embodiment of the above aspect, the circuitry is configured to select the channel to maximize a bandwidth of the connection. This embodiment selects the channel such as to maximize the band width and thereby allows for an increase in effective throughput.

(3) According to another embodiment of the above aspect, the circuitry is configured to select the channel to maximize an effective throughput of the connection. This embodiment selects the channel such as to maximize the effective throughput and thereby allows for transmission and reception of large-volume data.

(4) According to another embodiment of the above aspect, the circuitry is configured to select the channel to minimize interference. This embodiment selects the channel such as to minimize interference of radio wave and thereby suppresses interruption of wireless communication.

(5) According to another embodiment of the above aspect, the circuitry is configured to detect a radar wave at the channel for which connection has been established; classify the channel at which the radar wave is detected as an unavailable channel; and select the one or more channels among the plurality of available channels when the radar wave is detected.

(6) According to another embodiment of the above aspect, the circuitry is configured to detect a link rate of communication being lower than a reference value; and select the one or more channels among the plurality of available channels when the lower link rate is detected. This embodiment allows for elimination of a state that the link rate is lower than the reference value.

(7) According to another embodiment of the above aspect, the circuitry is configured to detect a transmission standby frequency being equal to or higher than a reference value; and select the one or more channels among the plurality of available channels when the frequency that is equal to or higher than the reference value is detected. This embodiment allows for suppression of interference with wireless communication by another device.

(8) According to another embodiment of the above aspect, the circuitry is configured to detect an interference signal strength being equal to or higher than a reference value at the channel for which connection has been established during non-communication of the information processing apparatus; and select the one or more channels among the plurality of available channels when the strength that is equal to or higher than the reference value is detected. This embodiment allows for avoidance of interference when communication starts.

(9) According to another embodiment of the above aspect, the circuitry is configured to select, when there are a plurality of selectable options meeting a throughput required by another device as a communication partner, a channel used for the communication that provides a narrower bandwidth. This embodiment avoids a band from being occupied beyond necessity.

(10) According to another embodiment of the above aspect, the circuitry is configured to select a channel for which connection is to be established among channels for which connection has not yet been established when no available channel is included in the channel for which connection has been established. When the channels for which connection is established do not include any available channel, this embodiment can select a channel for which connection is newly established.

(20) An information processing apparatus comprising: circuitry configured to determine, when a first condition is satisfied, that a channel currently used for communication should be switched to another channel; classify each of a plurality of channels as an unavailable channel or an available channel based on a characteristic of each channel; and set, when the first condition is satisfied, a channel for subsequent communication based on the channels classified as available.

The plurality of structural components included in each aspect of the disclosure described above are not all essential, but some structural components among the plurality of structural components may be appropriately changed, omitted or replaced with other structural components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the disclosure described above may be combined with part or all of the technical features included in another aspect of the disclosure described above to provide still another independent aspect of the disclosure.

For example, one aspect of the disclosure may be implemented as a device including part or all of the two actions: to classify and to select. In other words, this device may classify or may not classify. This device may select or may not select. To classify may be, for example, to classify a channel for which connection has been established as an unavailable channel or an available channel. To select may be, for example, to select, when there are a plurality of available channels, one or more channels among the plurality of available channels as a channel for which connection is to be maintained. This device may be implemented, for example, as a wireless communication device but may also be implemented as a different device other than the wireless communication device. This aspect can solve at least one of various problems, for example, downsizing of a device, cost reduction, resource saving, easiness of manufacture and improved usability. Part of all of the technical features involved in the respective embodiments of the wireless communication device described above may also be applicable to this device.

The disclosure may be implemented by any various aspects other than those described above: for example, a wireless communication channel selecting method, a program configured to implement this method, and a non-transitory storage medium in which this program is stored.

1. An information processing apparatus, comprising:
circuitry configured to
classify a channel for which connection has been established as an unavailable channel or an available channel; and
select, when there are a plurality of available channels, one or more channels among the plurality of available channels as a channel for which connection is to be maintained.

2. The information processing apparatus according to claim 1, wherein
the circuitry is configured to select the channel to maximize a bandwidth of the connection.

3. The information processing apparatus according to claim 1, wherein
the circuitry is configured to select the channel to maximize an effective throughput of the connection.

4. The information processing apparatus according to claim 1, wherein
the circuitry is configured to select the channel to minimize interference.

5. The information processing apparatus according to claim 1, wherein
the circuitry is configured to
detect a radar wave at the channel for which connection has been established;
classify the channel at which the radar wave is detected as an unavailable channel; and
select the one or more channels among the plurality of available channels when the radar wave is detected.

6. The information processing apparatus according to claim 1, wherein
the circuitry is configured to
detect a link rate of communication being lower than a reference value; and
select the one or more channels among the plurality of available channels when the lower link rate is detected.

7. The information processing apparatus according to claim 1, wherein
the circuitry is configured to
detect a transmission standby frequency being equal to or higher than a reference value; and
select the one or more channels among the plurality of available channels when the frequency that is equal to or higher than the reference value is detected.

8. The information processing apparatus according to claim 1, wherein
the circuitry is configured to
detect an interference signal strength being equal to or higher than a reference value at the channel for which connection has been established during non-communication of the information processing apparatus; and
select the one or more channels among the plurality of available channels when the strength that is equal to or higher than the reference value is detected.

9. The information processing apparatus according to claim 1, wherein
the circuitry is configured to select, when there are a plurality of selectable options meeting a throughput required by another device as a communication partner, a channel used for the communication that provides a narrower bandwidth.

10. The information processing apparatus according to claim 1, wherein
the circuitry is configured to select a channel for which connection is to be established among channels for which connection has not yet been established when no available channel is included in the channel for which connection has been established.

11. A method, comprising:
classifying a channel for which connection has been established as an unavailable channel or an available channel; and
selecting, when there are a plurality of available channels, one or more channels among the plurality of available channels as a channel for which connection is to be maintained.

12. The method according to claim 11, wherein
the selecting includes selecting a channel to maximize a bandwidth of the connection.

13. The method according to claim 11, wherein
the selecting includes selecting a channel to maximize an effective throughput of the connection.

14. The method according to claim 11, wherein
the selecting includes selecting a channel to minimize interference.

15. The method according to claim 11, further comprising
detecting a radar wave at the channel for which connection has been established; wherein
the classifying includes classifying the channel at which the radar wave is detected as an unavailable channel; and
the selecting includes selecting the one or more channels among the plurality of available channels when the radar wave is detected.

16. The method according to claim 11, further comprising
detecting a link rate of communication being lower than a reference value; wherein
the selecting includes selecting the one or more channels among the plurality of available channels when the lower link rate is detected.

17. The method according to claim 11, further comprising
detecting a transmission standby frequency being equal to or higher than a reference value; wherein
the selecting includes selecting the one or more channels among the plurality of available channels when the frequency that is equal to or higher than the reference value is detected.

18. The method according to claim 11, further comprising
detecting an interference signal strength being equal to or higher than a reference value at the channel for which connection has been established during non-communication of the information processing apparatus; wherein
the selecting includes selecting the one or more channels among the plurality of available channels when the strength that is equal to or higher than the reference value is detected.

19. The method according to claim 11, wherein
the selecting includes selecting, when there are a plurality of selectable options meeting a throughput required by another device as a communication partner, a channel used for the communication that provides provide a narrower bandwidth.

20. An information processing apparatus comprising:
circuitry configured to
determine, when a first condition is satisfied, that a channel currently used for communication should be switched to another channel;
classify each of a plurality of channels as an unavailable channel or an available channel based on a characteristic of each channel; and
set, when the first condition is satisfied, a channel for subsequent communication based on the channels classified as available.
